(19) United States
(12) Patent Application Publication
(10) Pub. No.: US 2015/0288068 A1
(43) Pub. Date: Oct. 8, 2015

(54) PRIMARY RADIATOR

(71) Applicant: SHARP KABUSHIKI KAISHA, Osaka (JP)

(72) Inventor: Eiji Suematsu, Osaka-shi (JP)

(73) Assignee: SHARP KABUSHIKI KAISHA, Osaka-shi, Osaka (JP)

(21) Appl. No.: 14/440,757

(22) PCT Filed: Oct. 31, 2013
(86) PCT No.: PCT/JP2013/079522

§ 371 Date: May 5, 2015

(30) Foreign Application Priority Data
Nov. 6, 2012 (JP) 2012-244684

(51) Int. Cl. H01Q 13/02

(52) U.S. Cl. CPC H01Q 13/02

(57) ABSTRACT

A feed horn includes a plurality of primary radiating elements. The plurality of primary radiating elements each include a waveguide having an opening. At least two primary radiating elements of the plurality of primary radiating elements each further include a radiating element of a dielectric material provided over the opening of the waveguide.

### TECHNICAL FIELD

The present invention relates to a primary radiator, and particularly relates to a primary radiator for radiating or receiving electric waves.

### BACKGROUND ART

A parabolic antenna receiving electric waves from a plurality of geostationary satellites at different longitudes on a geostationary orbit (arranged at intervals of eight degrees, for example) with one parabolic reflector is called a dual-beam antenna or a multi-beam antenna. The structure of such a parabolic antenna has been proposed. When receiving electric waves from two satellites, a first primary radiator that receives the electric wave from a first satellite and a second primary radiator that receives the electric wave from a second satellite are arranged at the focal point of a parabolic reflector.

Assume the case where the difference of longitude between the two satellites is small (e.g., 4 degrees). In a parabolic antenna in which a parabolic reflector of a predetermined aperture diameter is used, if the first and second primary radiators are arranged at their optimal positions so as to obtain desired radiation efficiency of the antenna, they will physically overlap each other. In order to solve such a problem, Japanese Patent Laying-Open No. 10-308628 (PTD 1) discloses a complex primary radiator having a structure in which two primary radiators are united and integrated at a predetermined position.

### CITATION LIST

### Patent Document

PTD 1: Japanese Patent Laying-Open No. 10-308628

### SUMMARY OF INVENTION

### Technical Problem

FIG. 12 illustrates a plan view and a cross-sectional view showing the structure of a conventional primary radiator. Referring to FIG. 12, FIG. 12(A) is a plan view of a complex primary radiator 50 disclosed in PTD 1. FIG. 12 (B) is a cross-sectional view of complex primary radiator 50 taken along the line XIIB-XIIB of FIG. 12(A).

Complex primary radiator 50 includes circular waveguides 203, 204 and horns 211, 212. Horns 211 and 212 are shaped so as to be connected at the bottom to circular waveguides 203 and 204, respectively, and to have an aperture diameter increasing toward the aperture plane. Horns 211 and 212 have a united section 205 at a predetermined position on the same aperture plane to assume an integrated structure. Corrugated grooves 213 and 214 having predetermined width and depth are arranged on the peripheries of horns 211 and 212, respectively. Corrugated grooves 213 and 214 also have a similarly united and integrated structure.

In the complex primary radiator disclosed in PTD 1, corrugated grooves 213 and 214 are different in size if electric waves from two satellites have largely different frequency bands, (e.g., by more than or equal to 30%). Therefore, corrugated grooves 213 and 214 are difficult to unite with each other.

Moreover, if the difference of longitude between the two satellites is even smaller (e.g., 1.8 degrees to 3.6 degrees), it will be necessary to bring circular waveguide 203 and horn 211 even closer to circular waveguide 204 and horn 212, for example. Therefore, with complex primary radiator 50, it is very difficult to manage the case where the difference of longitude between the two satellites is even smaller.

The present invention has an object to provide a primary radiator capable of radiating or receiving electric waves even if the difference of longitude between a plurality of satellites is small and those satellites have different frequency bands from each other.

### Solution to Problem

According to an aspect of the present invention, a primary radiator includes a plurality of primary radiating elements. The plurality of primary radiating elements each include a waveguide having an opening. At least two primary radiating elements of the plurality of primary radiating elements each further include a radiating element of a dielectric material provided over the opening of the waveguide.

Preferably, the radiating element has a radiant part located on an outer side of the opening of the waveguide, and an impedance matching part to be inserted into the opening of the waveguide. The radiant part has a cross section of a cruciform along the entire length of the radiant part. The length of a side of the cruciform decreases with distance from the opening of the waveguide.

Preferably, the radiating element has a radiant part located on an outer side of the opening of the waveguide, and an impedance matching part to be inserted into the opening of the waveguide. The radiant part has a shape of one of a truncated cone and a truncated pyramid. A hollow portion is formed in the truncated cone and the truncated pyramid.

Preferably, the waveguide has a cross section of one of a square and a circle. Along the entire length of the impedance matching part, the impedance matching part has an axially symmetric shape with respect to two axes passing through the center of the cross section of the waveguide and perpendicular to each other in the cross section.

Preferably, the impedance matching part has a corrugated groove provided along the opening of the waveguide.

### Advantageous Effects of Invention

According to the present invention, a primary radiator capable of radiating or receiving electric waves even if the difference of longitude between a plurality of satellites is small and those satellites have different frequency bands from each other can be achieved.

### BRIEF DESCRIPTION OF DRAWINGS

FIG. 1 is an outside perspective view showing the outline of a parabolic antenna including a primary radiator according to a first embodiment of the present invention.

FIG. 2 is a plan view showing the outline of the parabolic antenna shown in FIG. 1.

FIG. 3 is an outside perspective view showing the shape of the primary radiator shown in FIG. 1.

FIG. 4 is an outside perspective view showing the outline of the primary radiator with a cap shown in FIG. 3 detached therefrom.

FIG. 5 is a plan view showing the outline of the primary radiator shown in FIG. 4.

FIG. 6 is a cross-sectional view showing the outline of the cross section of the primary radiator taken along the line VI-VI of FIG. 5.

FIG. 7 illustrates an outside perspective view and a plan view showing the structure of a dielectric rod shown in FIG. 6.

FIG. 8 illustrates radiation pattern characteristics in the φ direction in the parabolic antenna shown in FIG. 1.

FIG. 9 illustrates radiation pattern characteristics in the θ direction in the parabolic antenna shown in FIG. 1.

FIG. 10 illustrates an outside perspective view and a plan view showing the structure of a dielectric rod in a primary radiator according to a second embodiment of the present invention.

FIG. 11 illustrates an outside perspective view and a plan view showing the structure of a dielectric rod in a primary radiator according to a third embodiment of the present invention.

FIG. 12 illustrates a plan view and a cross-sectional view showing the structure of a conventional primary radiator.

### DESCRIPTION OF EMBODIMENTS

Hereinafter, embodiments of the present invention will be described in detail with reference to the drawings. It is noted that, in the drawings, the same or corresponding portions have the same reference characters allotted, and description thereof will not be repeated.

Linearly polarized waves or circularly polarized waves are adopted as electric waves used with satellites, such as broadcasting satellites or communication satellites. An antenna for receiving linearly polarized waves receives either or both of vertically polarized waves and horizontally polarized waves. An antenna for receiving circularly polarized waves receives either or both of right-hand circularly polarized waves and left-hand circularly polarized waves. A circularly polarized wave is obtained by combining a vertically polarized wave and a horizontally polarized wave. When one of the vertically polarized wave and the horizontally polarized wave has a phase lead of 90 degrees with respect to the other one, the circularly polarized wave is called a right-hand circularly polarized wave or a left-hand circularly polarized wave.

In embodiments which will be described below, a feed horn (primary radiator) according to the embodiments of the present invention is used to mainly receive a plurality of linearly polarized waves or circularly polarized waves (plurality of polarized waves). With the structure capable of receiving a plurality of polarized waves, however, only one polarized wave (a single polarized wave) among them can also be received. It is noted that the feed horn according to the embodiments of the present invention can be used not only for receiving electric waves but also for radiating (transmitting) electric waves.

### First Embodiment

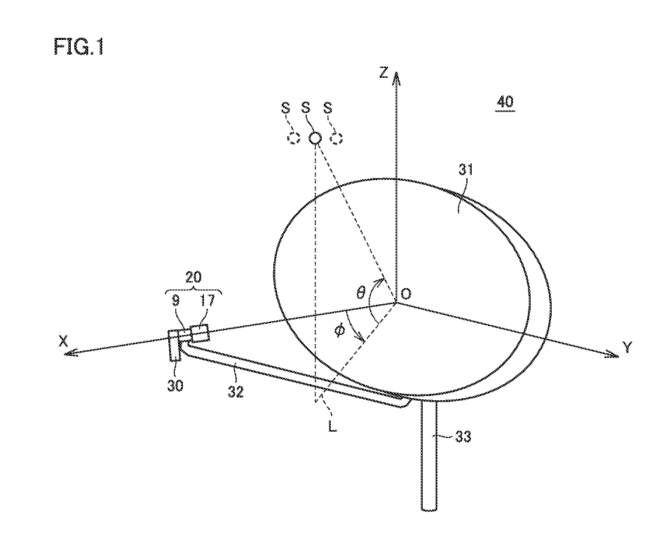

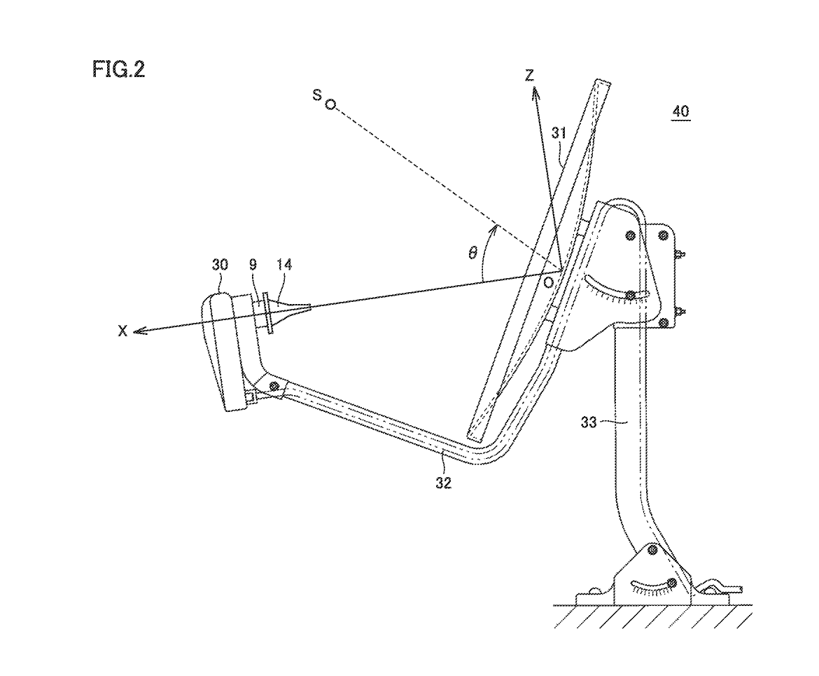

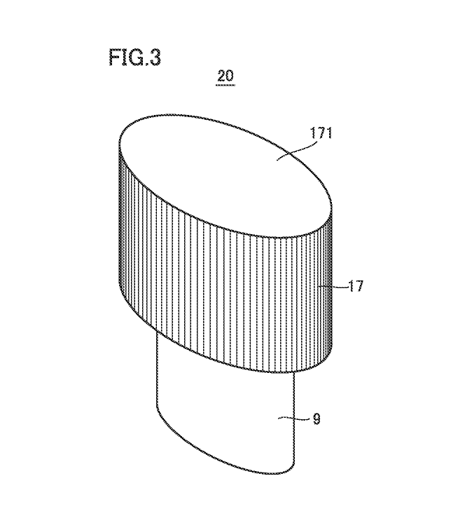

FIG. 1 is an outside perspective view showing the outline of a parabolic antenna including a feed horn according to a first embodiment of the present invention. FIG. 2 is a plan view showing the outline of the parabolic antenna shown in FIG. 1. FIG. 3 is an outside perspective view showing the shape of the feed horn shown in FIG. 1.

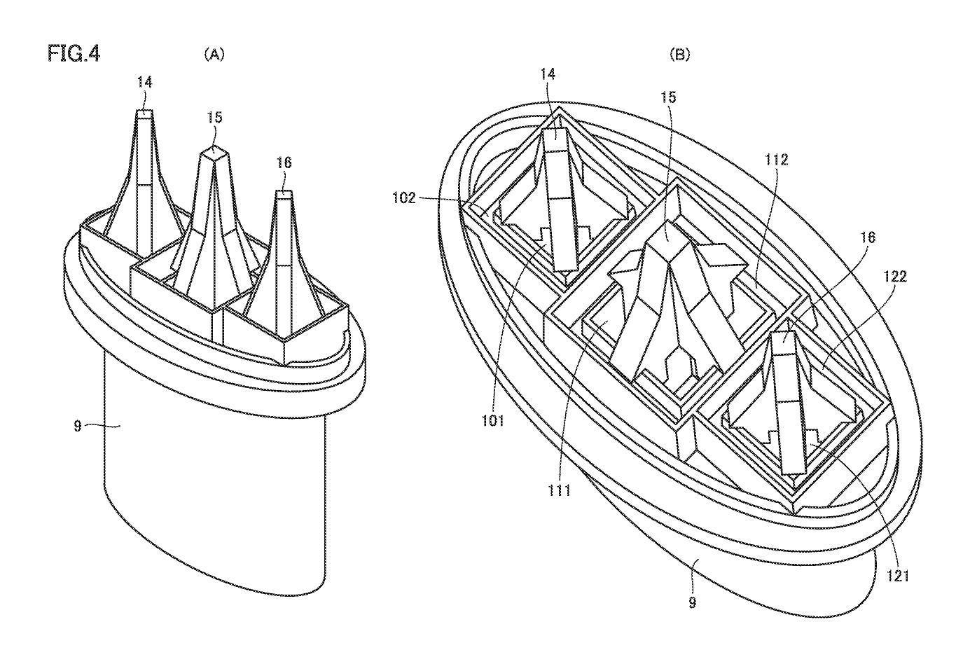

Referring to FIGS. 1 to 3, a parabolic antenna 40 includes a feed horn 20, a satellite receiving converter (frequency converter) (hereinafter LNB (Low Noise Block down-converter)) 30, a parabolic reflector 31, a support arm 32, and a support mast 33. Feed horn 20 includes a main body 9 and a cap 17 attached to main body 9. It is noted that in FIG. 2 cap 17 has been detached from main body 9 to show the orientation of a dielectric rod (radiating element) 14 (see FIG. 4).

Parabolic antenna 40 is an offset parabolic antenna, and is horizontally mounted at an installation position with support mast 33. Parabolic reflector 31 has an elliptical shape whose longitudinal axis extends in the horizontal direction. The straight line connecting the center (origin O) of parabolic reflector 31 and the center of feed horn 20 is defined as the X-axis. The horizontal direction passing through origin O (the direction perpendicular to the sheet of drawing of FIG. 2) is defined as the Y-axis. The direction perpendicular to the X-axis and the Y-axis is defined as the Z-axis.

Support arm 32 has one end mounted at support mast 33. At the other end of support arm 32, feed horn 20 is mounted at the focal point of parabolic reflector 31. An electric wave from a satellite S is received by feed horn 20 for output to LNB 30. LNB 30 converts the frequency of this electric wave into a lower frequency for output to a tuner not shown, for example.

Parabolic antenna 40 is installed so as to face satellite S. The direction of satellite S is expressed by angles φ and θ. Angle φ is an angle made by a straight line L connecting a projected point of satellite S on the X-Y plane and origin O with respect to the X-axis. Angle θ is an angle made by a straight line connecting satellite S and origin O with respect to straight line L. Angle φ corresponds to the longitude of satellite S. When there are a plurality of satellites S (in the case of multiple satellites), these satellites are aligned such that angle θ is almost common and angle φ differs by several degrees (e.g., 1.8 degrees to 4 degrees). The direction of the longitudinal axis of parabolic reflector 31 corresponds to the direction in which plurality of satellites S are aligned. Therefore, parabolic antenna 40 is capable of efficiently receiving electric waves from plurality of satellites S.

Main body 9 has conductivity and the material thereof is an aluminum die cast as an example. Cap 17 has an elliptic cylindrical shape. The material and structure of cap 17 will be described later in detail.

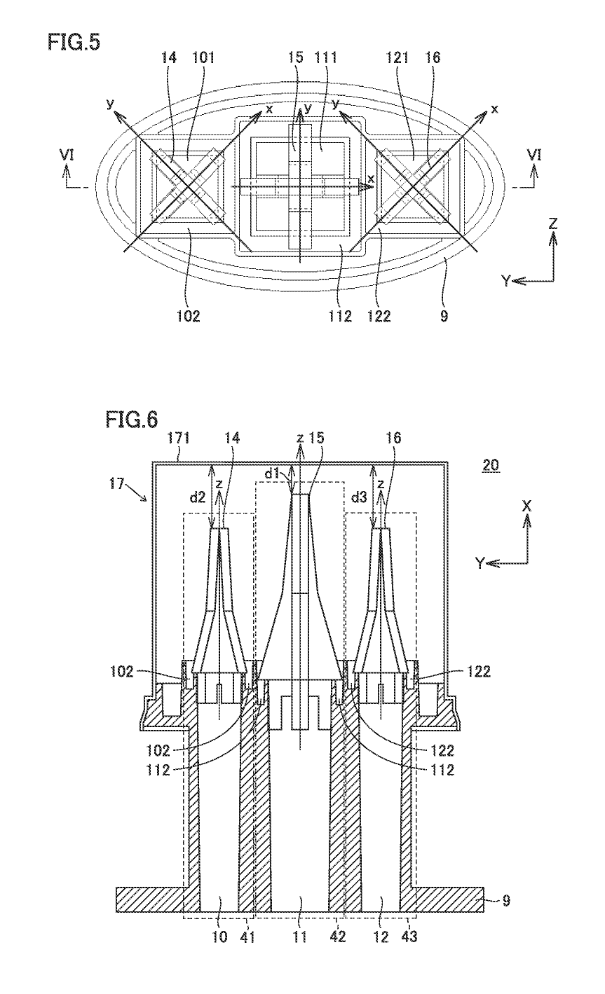

FIG. 4 is an outside perspective view showing the outline of feed horn 20 with cap 17 shown in FIG. 3 detached therefrom. FIG. 5 is a plan view showing the outline of feed horn 20 shown in FIG. 4. FIG. 6 is a cross-sectional view showing the outline of the cross section of feed horn 20 taken along the line VI-VI of FIG. 5. It is noted that FIG. 6 shows the state where cap 17 has been attached to main body 9.

Referring to FIGS. 4 to 6, the function of feed horn 20 is to obtain impedance matching between free space (air on the ground) and a waveguide for transmission with little reflection and to obtain a radiation pattern (directional characteristics) in accordance with the angle of aperture of parabolic reflector 31 as seen from feed horn 20 (see FIG. 1). Feed horn 20 is equipped with three primary radiating elements 41 to 43 corresponding to frequency bands of different operating frequencies from each other. Primary radiating element 41 includes a waveguide 10, a dielectric rod 14, and a corrugated groove 102. Primary radiating element 42 includes a waveguide 11, a dielectric rod 15, and a corrugated groove 112. Primary radiating element 43 includes a waveguide 12, a dielectric rod 16, and a corrugated groove 122. Primary radiating element 41 corresponds to a Ka band, for example. Primary radiating element 42 corresponds to a Ku band, for example. Primary radiating element 43 corresponds to a Ka band, for example. By integrating primary radiating elements 41 to 43, feed horn 20 reduced in size can be achieved.

Waveguides 10 to 12 have openings 101, 111 and 121, respectively. Waveguides 10 to 12 are also open at the other ends. Waveguides 10 to 12 have a square cross section. It is noted that waveguides 10 to 12 may have a cross section of a perfect circle.

Grooves called corrugated grooves 102, 112 and 122 are provided on the peripheries of openings 101, 111 and 121, respectively. By providing corrugated grooves 102, 112 and 122 around dielectric rods 14 to 16, respectively, impedance matching between waveguides 10 to 12 and the radiant parts of dielectric rods 14 to 16 is improved. Reception of unnecessary waves can thereby be restrained. As a result, a favorable radiation pattern having suppressed side lobe and high radiation efficiency can be obtained. It is preferable to set each of corrugated grooves 102, 112 and 122 to have a depth of about ¼ of a wavelength corresponding to the center frequency of an electric wave they each receive (and the wavelength in free space). It is noted that although corrugated grooves 102, 112 and 122 are illustrated only by a round on the peripheries of openings 101, 111 and 121, respectively, they may be provided by several rounds.

Dielectric rods 14 to 16 are partially inserted into waveguides 10 to 12, respectively. Each of dielectric rods 14 to 16 has a function similar to that of a dielectric lens antenna. Therefore, by modifying the shape (size, height or thickness) of each of dielectric rods 14 to 16, primary radiating elements 41 to 43 can be easily adjusted in beam width and/or radiant gain independently from each other. Electric waves from a plurality of satellites having different frequency bands can thereby be received.

More specifically, for each of dielectric rods 14 to 16, the direction in which dielectric rods 14 to 16 are inserted into waveguides 10 to 12, respectively, is defined as the z-axis. The cross section perpendicular to the z-axis is cruciform. The x-axis is defined along one side of the cruciform, and the y-axis is defined along the other side.

The z-axis of each of dielectric rods 14 to 16 lies in the X-Y plane. Dielectric rod 15 is arranged such that the direction of the y-axis corresponds to the Z-axis direction. Dielectric rod 15 thus looks like “+” when the Y-Z plane is seen such that the Y-axis extends horizontally (see FIG. 5). On the other hand, each of dielectric rods 14 and 16 is arranged at an angle of 45 degrees around the z-axis with respect to the arrangement of dielectric rod 15. Each of dielectric rods 14 and 16 thus looks like “x” when the Y-Z plane is seen such that the Y-axis extends horizontally. Hereinafter, in the present specification, such an arrangement of dielectric rods 14 to 16 will be referred to as an arrangement of “x+x.”

Dielectric rod 14 has a biaxially symmetric structure. Waveguides 10 to 12 have a square cross section. Therefore, waveguide 10 and dielectric rod 14 are both axially symmetric about the x-axis and the y-axis. The same applies to dielectric rods 15 and 16. Therefore, since the axial ratio becomes equivalent when converters that convert linearly polarized waves into circularly polarized waves are provided within waveguides 10 to 12, primary radiating elements 41 to 43 can generate circularly polarized waves. On the contrary, when the symmetry about the x-axis and the y-axis is destroyed, the axial ratio will deviate from a value that provides circularly polarized waves and approach a value that provides elliptically polarized waves. Therefore, the cross polarization characteristic will deteriorate to decrease the cross polarization discrimination between right-hand circularly polarized waves and left-hand circularly polarized waves.

Hereinafter, dielectric rod 14 will be described representatively. The size and shape of dielectric rods 15 and 16 are different from the size and shape of dielectric rod 14 depending on their corresponding frequency bands. However, dielectric rods 14 to 16 have a common basic structure.

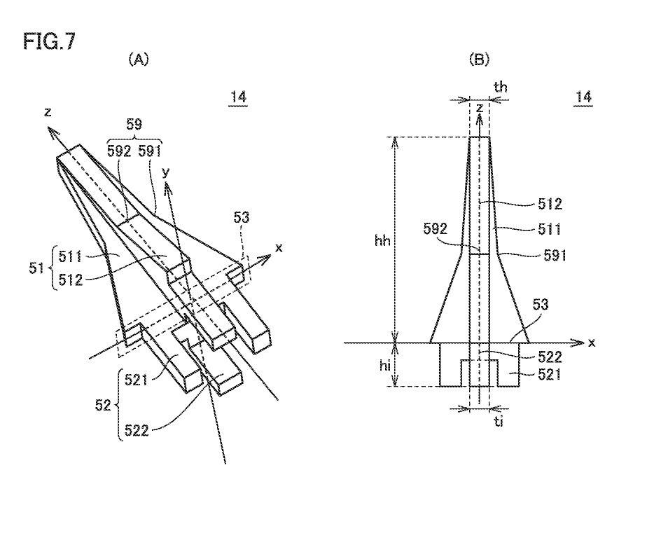

FIG. 7 illustrates an outside perspective view and a plan view showing the structure of dielectric rod 14 shown in FIG. 6. Referring to FIG. 7, as the material of dielectric rod 14, polypropylene (having a relative dielectric constant of about 2.2) is used, for example. Dielectric rod 14 includes a radiant part 51 located on the outer side of opening 101 of waveguide 10 and an impedance matching part 52 to be inserted into opening 101 of waveguide 10. The boundary between radiant part 51 and impedance matching part 52 is denoted as a boundary plane 53.

Radiant part 51 is mainly provided to receive electric waves more efficiently. The cross section of radiant part 51 perpendicular to the axial direction of waveguide 10 (z-axis direction) is cruciform along the entire length thereof, and the length of a side of the cruciform decreases with distance from opening 101 of waveguide 10. More specifically, generally trapezoidal plate-like trapezoidal portions 511 and 512 are combined together to be perpendicular to each other. Necks 591 and 592 are formed in trapezoidal portions 511 and 512, respectively. Trapezoidal portions 511 and 512 each have a thickness th. The shape of radiant part 51 may be a plate shape in agreement with the direction of polarized waves. That is, when receiving a single polarized wave, only either trapezoidal portion 511 or 512 will be sufficient. When receiving a plurality of polarized waves, however, a shape obtained by combining two plates together to be perpendicular to each other is required. With the structure in which trapezoidal portions 511 and 512 are combined together, a plurality of polarized waves can be received. It is noted that the leading edge of radiant part 51 may have an acute angle.

When the difference of longitude between two satellites is still smaller (e.g., 1.8 degrees to 3.6 degrees), the beam width needs to be narrowed in order to receive an electric wave from one of the two satellites and prevent interference by an electric wave from the other one. The beam width is inversely proportional to the antenna gain. It is therefore indispensable to increase the antenna gain by increasing the size of a horn. With complex primary radiator 50 disclosed in PTD 1, however, horns 211 and 212 are widened to assume an inverted conical shape in the axial direction of circular waveguides 203 and 204, respectively. Therefore, if horns 211 and 212 are increased in size, the spacing between horns 211 and 212 will be widened. Accordingly, the position of horns 211 and 212 will be displaced from the focal point of the parabolic reflector, so that the antenna gain will be reduced.

The spacing between the horns is proportional to the aperture diameter of the parabolic reflector. Widening of the spacing between the horns can be managed by increasing the aperture diameter of the parabolic reflector. However, the space in which the parabolic antenna is installed is usually restricted. As the aperture diameter of the parabolic reflector is smaller, the parabolic antenna is installed more easily, and safety from wind is higher. Therefore, in particular for a parabolic antenna for home use, it is not realistic to increase the aperture diameter of the parabolic reflector. Also from this point of view, it is difficult to widen the spacing between the horns.

On the other hand, in feed horn 20 according to the first embodiment, the radiant gain and beam width (or antenna gain) of feed horn 20 can be modified by adjusting the shape of dielectric rods 14 to 16, more specifically, a height hh of radiant part 51, a thickness ti of radiant part 51, as well as the position and size of constriction 59. Consequently, it is not necessary to widen the spacing among primary radiating elements 41 to 43. Therefore, the case where the difference of longitude between a plurality of satellites is small can be managed without increasing the aperture diameter of parabolic reflector 31.

Moreover, since the shape of radiant part 51 is cruciform, radiant part 51 has a large surface area exposed to air. Therefore, the equivalent dielectric constant of radiant part 51 becomes smaller than the dielectric constant of the material thereof to become closer to the dielectric constant of air. Accordingly, impedance matching can be improved to reduce the loss caused by radiant part 51, and the band can be extended. As a result, primary radiating elements 41 to 43 are each improved in radiation efficiency, so that the radiation efficiency of feed horn 20 is improved. Therefore, the radiation efficiency of parabolic antenna 40 as a whole is improved.

Impedance matching part 52 obtains impedance matching between waveguide 10 and radiant part 51. More specifically, impedance matching part 52 includes plate-like recessed portions 521 and 522 provided with recesses in the axial direction of waveguide 10. As for dielectric rod 14, recessed portions 521 and 522 are inserted into waveguide 10 such that boundary plane 53 is located at opening 101 of waveguide 10. Transition is thereby gradually made in waveguide 10 from hollow to dielectric along the axial direction. Accordingly, the change in dielectric constant while electric waves are transmitted from waveguide 10 to dielectric rod 14 becomes gentle. Therefore, electric waves are more likely to pass through dielectric rod 14, so that the proportion of electric waves reflected from dielectric rod 14 decreases, which can reduce the loss.

Moreover, impedance matching can be improved by adjusting a height hi of impedance matching part 52, a thickness ti of impedance matching part 52, as well as the position and size of the recesses.

Furthermore, in dielectric rod 14, the shape of radiant part 51 and the shape of impedance matching part 52 can be modified independently. The beam width (or antenna gain) and impedance matching can thereby be adjusted almost independently from each other. Therefore, feed horn 20 having a wide band, little loss and high efficiency can be achieved.

Returning to FIG. 2, the arrangement of primary radiating elements 41 to 43 with respect to parabolic reflector 31 will be described below in detail. As described above, parabolic reflector 31 has an elliptical shape whose longitudinal axis extends in the horizontal direction. As seen from each of primary radiating elements 41 to 43, a radiation pattern of feed horn 20 in which the wide beam width is wide in the horizontal direction and the beam width is narrow in the vertical direction will increase the antenna gain and improve the efficiency with respect to parabolic reflector 31. Therefore, each of primary radiating elements 41 to 43 preferably has a radiation pattern in which the beam width is wide in the horizontal plane direction and the beam width is narrow in the vertical plane direction so as to correspond to the shape of parabolic reflector 31. Accordingly, when provided with parabolic reflector 31 having an elliptical shape, parabolic antenna 40 having high antenna gain and high efficiency can be achieved. Therefore, dielectric rods 14 to 16 are arranged in alignment with each other on the horizontal plane. In FIG. 2, dielectric rods 15 and 16 are arranged behind dielectric rod 14 with respect to the sheet of drawing.

Interactions resulting from an electromagnetic field occur among dielectric rods 14 to 16. More specifically, when dielectric rod 15 receives electric waves, for example, dielectric rods 14 and 16 function as sub-antennas for dielectric rod 15. Similarly, when dielectric rods 14 and 16 receive electric waves, for example, dielectric rod 15 functions as a sub-antenna for dielectric rods 14 and 16. Also when all of dielectric rods 14 to 16 simultaneously receive electric waves from their corresponding satellites, each of dielectric rods 14 to 16 functions as a sub-antenna for another dielectric rod functioning as a main antenna. Accordingly, the width of beam in the horizontal plane direction received by feed horn 20 is widened. Therefore, the antenna gain of parabolic antenna 40 increases.

Arranging dielectric rods 14 to 16 to assume “+++” or “xxx” may also be considered. With this arrangement, however, all the interactions resulting from the electromagnetic field among dielectric rods 14 to 16 will be in the same direction in the case of horizontally polarized waves and vertically polarized waves. Therefore, the interactions among dielectric rods 14 to 16 will become excessively strong. Accordingly, the axial ratio slightly approaches from a value that provides circularly polarized waves to a value that provides elliptically polarized waves.

On the other hand, according to the first embodiment, dielectric rods 14 to 16 are arranged to assume “x+x”. In this case, as compared to the arrangement assuming “+++” or “xxx”, the interactions among respective dielectric rods 14 to 16 resulting from the electromagnetic field are reduced to be a suitable strength. Accordingly, the axial ratio close to circularly polarized waves can be maintained. As a result, the cross polarization characteristic of each of primary radiating elements 41 to 43 can be improved. It is noted that dielectric rods 14 to 16 may be arranged so as to assume “+x+”.

Returning to FIG. 6, the structure of cap 17 will be described below in detail. Cap 17 is provided to cover dielectric rods 14 to 16 as a whole. The relative dielectric constant of water is approximately 80. Therefore, when raindrops directly touch dielectric rods 14 to 16, the apparent shape (the distribution of dielectric constant) of dielectric rods 14 to 16 as seen from electric waves will change. Accordingly, feed horn 20 will become unable to receive electric waves stably as designed. By providing cap 17, cap 17 is filled with air to prevent raindrops from adhering to dielectric rods 14 to 16. Therefore, feed horn 20 can receive electric waves stably as designed even during rainfall.

The dielectric constant of cap 17 is preferably set to be equivalent to or less than that of dielectric rods 14 to 16. For example, polypropylene is used for cap 17 similarly to dielectric rods 14 to 16, and the thickness thereof is approximately 0.8 mm. By bringing the dielectric constant of cap 17 closer to that of air, impedance matching between cap 17 and air is improved. The loss in cap 17 can thereby be reduced.

Each of distances d1 to d3 between the leading edge of radiant part 51 of dielectric rods 14 to 16 and a bottom 171 of cap 17 is preferably an integral multiple of, and more preferably, equal to or twice about λ/2 (λ: the wavelength of electric waves corresponding to each of primary radiating elements 41 to 43). During radiation of electric waves, part of electric waves radiated from the leading edge of radiant part 51 is reflected from bottom 171 to return to dielectric rods 14 to 16. When each of distances d1 to d3 is an integral multiple of λ/2, the distance over which electric waves travel to and fro becomes an integral multiple of λ. Therefore, electric waves radiated from dielectric rods 14 to 16 and electric waves reflected from cap 17 are combined in the same phase. Accordingly, efficient radiation of electric waves becomes possible. It is noted that when receiving electric waves, similar effects can also be obtained since reflection from bottom 171 occurs.

It is noted that cap 17 has an elliptic cylindrical shape. A constant distance can thereby be ensured between the leading edge of radiant part 51 of each of dielectric rods 14 to 16 and bottom 171 of cap 17. Cap 17 may have a prismatic shape. Alternatively, cap 17 may have one of an inverted truncated conical shape and an inverted truncated pyramidal shape which widens from impedance matching part 52 toward radiant part 51 along the axial direction of waveguides 10 to 12. Even when cap 17 has such a shape, effects similar to those of the case of the cylindrical shape can be obtained.

Furthermore, the distance between the leading edge of radiant part 51 of any one of dielectric rods 14 to 16 and the bottom of the cap may be an integral multiple of about λ/2. Cap 17 may have a shape of one of a truncated cone (or a conical shape) or a truncated pyramidal shape (or a pyramidal shape) which decreases from impedance matching part 52 toward radiant part 51 along the axial direction of waveguides 10 to 12. In this case, the leading edge of cap 17 becomes thinner, resulting in a reduced volume of cap 17. Feed horn 20 can thereby be reduced in size and made compact.

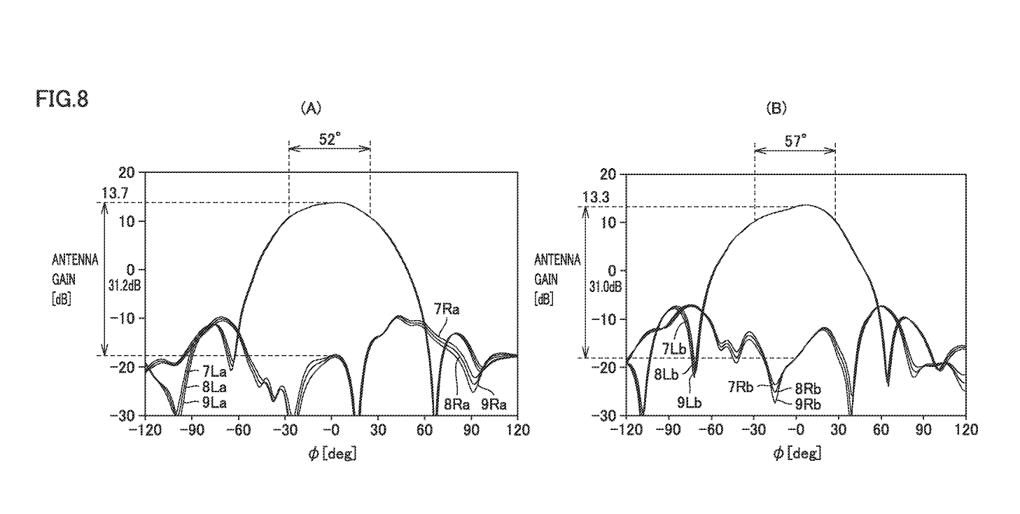

The result of measurements of the radiation pattern of parabolic antenna 40 equipped with feed horn 20 according to the first embodiment will be described below. FIG. 8 illustrates the radiation pattern characteristics in the φ direction in parabolic antenna 40 shown in FIG. 1. Referring to FIG. 8, the horizontal axis indicates the angle of satellite S in the φ direction. Angle θ is 57 degrees, 58 degrees or 59 degrees. The vertical axis indicates the antenna gain of parabolic antenna 40. FIG. 8(A) shows the case where only dielectric rod 14 is provided. FIG. 8(B) shows the radiation pattern characteristics of dielectric rod 14 in the case where three dielectric rods 14 to 16 are all provided.

Waveforms 7La, 8La and 9La indicate the radiation pattern characteristics of left-hand circularly polarized waves when angle θ is equal to 57 degrees, 58 degrees and 59 degrees, respectively. Waveforms 7Ra, 8Ra and 9Ra indicate the radiation pattern characteristics of right-hand circularly polarized waves when θ is equal to 57 degrees, 58 degrees and 59 degrees, respectively. The radiation pattern characteristics of left-hand circularly polarized waves are almost in agreement with one another irrespective of the value of angle θ. The same applies to the radiation pattern characteristics of right-hand circularly polarized waves.

In FIG. 8(A), the antenna gain has a maximum value of 13.7 dB and a cross polarization characteristic of 31.2 dB. The 3 dB bandwidth is 52 degrees. On the other hand, in FIG. 8(B), the antenna gain has a maximum value of 13.3 dB and a cross polarization characteristic of 31.0 dB. The 3 dB bandwidth is 57 degrees. Comparing FIGS. 8(A) and (B), the amount of change in the 3 dB bandwidth is large. That is, it is revealed that by increasing the number of dielectric rods 14 to 16, the radiation pattern of parabolic antenna 40 is significantly widened in the φ direction.

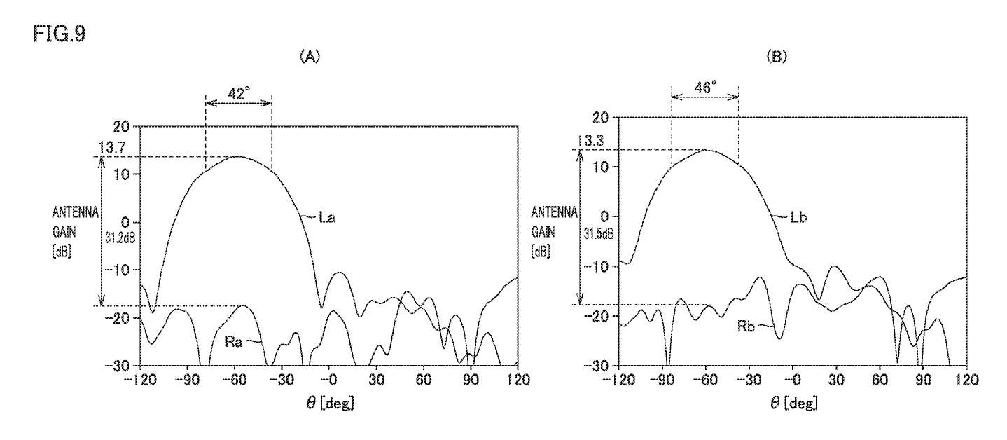

FIG. 9 illustrates the radiation pattern characteristics in the θ direction in parabolic antenna 40 shown in FIG. 1. Referring to FIG. 9, FIG. 9 is compared with FIG. 8. The horizontal axis indicates the angle of satellite S in the θ direction. Angle φ is 0 degree. Waveforms La and Lb indicate the radiation pattern characteristics of left-hand circularly polarized waves, and waveforms Ra and Rb indicate the radiation pattern characteristics of right-hand circularly polarized waves.

In FIG. 9(A), the antenna gain has a maximum value of 13.7 dB and a cross polarization characteristic of 31.2 dB. The 3 dB bandwidth is 42 degrees. On the other hand, in FIG. 9(B), the antenna gain has a maximum value of 13.3 dB and a cross polarization characteristic of 31.5 dB. The 3 dB bandwidth is 46 degrees. In this way, it is revealed that by increasing the number of dielectric rods 14 to 16, the radiation pattern of parabolic antenna 40 is slightly widened also in the θ direction.

### Second Embodiment

In the first embodiment, cruciform dielectric rods 14 to 16 are adopted, but dielectric rods 14 to 16 are not limited to this shape. According to a second embodiment, a dielectric rod including a truncated pyramidal radiant part is adopted.

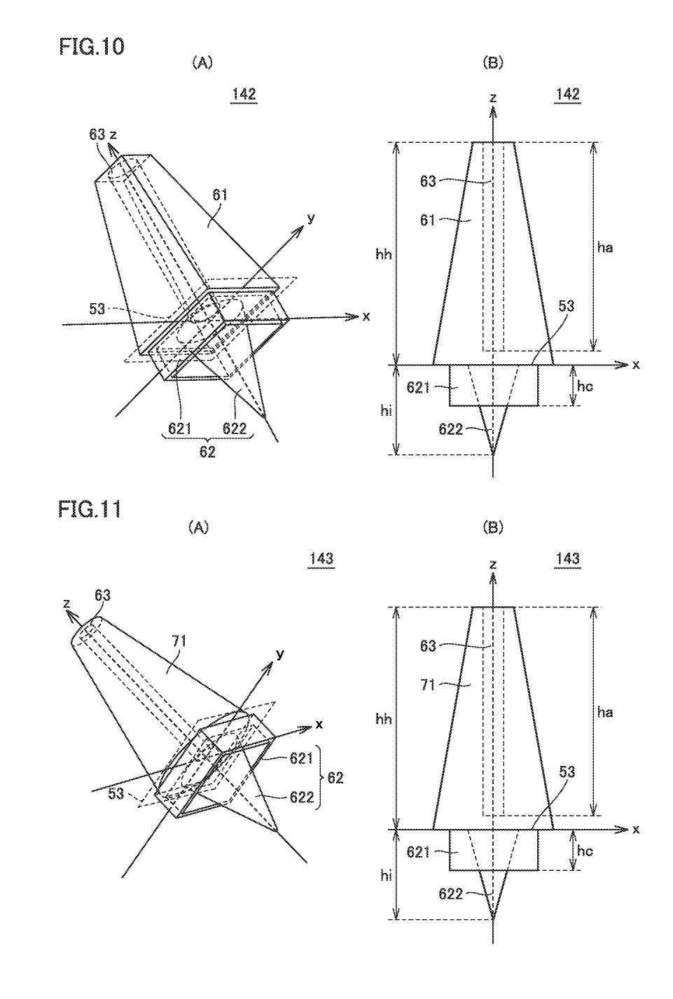

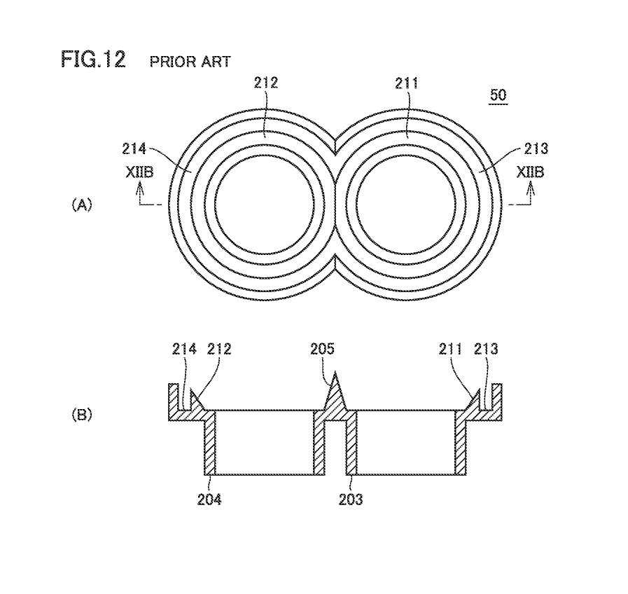

FIG. 10 illustrates an outside perspective view and a plan view showing the structure of a dielectric rod in a feed horn according to the second embodiment of the present invention. Referring to FIG. 10, the feed horn according to the second embodiment is equipped with a dielectric rod (hereinafter, a truncated pyramidal rod) 142 including a truncated pyramidal part. The remaining structure of the feed horn according to the second embodiment is equivalent to the structure of feed horn 20 according to the first embodiment, and a detailed description thereof will not be repeated.

Truncated pyramidal rod 142 includes a truncated pyramidal radiant part 61 and an impedance matching part 62. Radiant part 61 is provided with a cylindrical hollow portion 63 having a depth ha. By providing hollow portion 63, the equivalent dielectric constant of radiant part 61 becomes smaller than the dielectric constant of the material thereof to become closer to the dielectric constant of air. Accordingly, impedance matching is improved to reduce the loss caused by radiant part 61, and the band can be extended. As a result, the radiation efficiency of the primary radiating element is improved, and in turn the radiation efficiency of the parabolic antenna as a whole is improved.

The dielectric rod is a lump of a three-dimensional and large-volume resin material. Therefore, in production of the dielectric rod, a problem may arise during molding. More specifically, shrinkage of the material occurs in the hardening process after injecting the resin material melted at a high temperature into a mold. On this occasion, air bubbles may be produced within the resin material, or recesses called sink marks may be produced at the surface. When air bubbles produced are large, the equivalent dielectric constant of the dielectric rod as a whole changes. A portion including air bubbles and a portion not including air bubbles are different in dielectric constant. Therefore, characteristics such as the impedance matching or the radiation pattern differ from designed characteristics. Sink marks produced at the surface are determined as defects in appearance. According to the present embodiment, the dielectric rod is reduced in thickness by providing hollow portion 63. Therefore, the possibility that air bubbles or sink marks are produced in truncated pyramidal rod 142 can be reduced. The yield of dielectric rods is thereby improved. It is noted that hollow portion 63 is not limited to a cylindrical shape, but may have a prismatic shape, for example (rectangular solid as an example).

Impedance matching part 62 includes a corrugated groove 621 and a conical portion 622. Corrugated groove 621 is a square similarly to opening 101 of waveguide 10. Conical portion 622 has a perfect conical shape having height hi, and is provided in corrugated groove 621.

By providing conical portion 622, transition is gradually made in waveguide 10 from hollow to dielectric. Accordingly, the change in dielectric constant while electric waves are transmitted from waveguide 10 to dielectric rod 14 becomes gentle. Moreover, impedance matching between waveguide 10 and radiant part 61 can be improved by adjusting height hi of conical portion 622.

A depth hc of corrugated groove 621 is more preferably set to be about ¼ of the wavelength corresponding to the center frequency of a received electric wave (and the wavelength in free space). By providing corrugated groove 621, reception of unnecessary waves can be restrained similarly to conductive corrugated grooves 102, 112 and 122 (see FIG. 4). Moreover, electric waves are more likely to pass through truncated pyramidal rod 142, so that the proportion of electric waves reflected from truncated pyramidal rod 142 decreases, which can reduce the loss.

Corrugated groove 621 and conical portion 622 have a biaxially symmetric structure. Accordingly, the axial ratio close to circularly polarized waves can be maintained. As a result, the cross polarization characteristic of each of primary radiating elements 41 to 43 can be improved. It is noted that a pyramidal portion having a pyramidal shape may be provided instead of conical portion 622. In this case, the pyramidal shape preferably has a highly symmetric shape, and more preferably has a perfect pyramidal shape.

An adhesive may be applied to the periphery of corrugated groove 621. The adhesive can improve the adhesion and airtightness between corrugated groove 621 and waveguide 10. When waveguide 10 is cylindrical, the corrugated groove is preferably made annular in agreement with the shape.

### Third Embodiment

FIG. 11 illustrates an outside perspective view and a plan view showing the structure of a dielectric rod in a feed horn according to a third embodiment of the present invention. Referring to FIG. 11, the feed horn according to the third embodiment is equipped with a dielectric rod (hereinafter, a truncated conical rod) 143 including a truncated conical portion (a radiant part 71), instead of truncated pyramidal rod 142. The remaining structure of the feed horn according to the third embodiment is equivalent to the structure of feed horn 20 according to the first embodiment, and a detailed description thereof will not be repeated. With truncated conical rod 143, effects similar to those with truncated pyramidal rod 142 according to the second embodiment can be obtained.

It is noted that radiant part 51 and impedance matching part 52 of dielectric rod 14 according to the first embodiment can be combined appropriately with radiant part 61, 71 of truncated pyramidal rod 142 or truncated conical rod 143 and impedance matching part 62 according to the second or third embodiment. For example, radiant part 51 of dielectric rod 14 can be combined with impedance matching part 62 of truncated pyramidal rod 142. Independent of the shape of the dielectric rod, cap 17 is effective similarly to the first embodiment.

Feed horn 20 is provided with three primary radiating elements 41 to 43. However, the number of horns is not limited to this, but it should just be plural. It is not necessary to provide a dielectric rod for each of primary radiating elements 411 to 43. When at least two dielectric rods are provided, an interaction resulting from an electromagnetic field occurs between the dielectric rods.

The embodiments of the present invention can be summarized as follows.

Feed horn 20 including plurality of primary radiating elements 41 to 43, plurality of primary radiating elements 41 to 43 each including a waveguide having an opening, at least two primary radiating elements of plurality of primary radiating elements 41 to 43 each further including a dielectric rod of a dielectric material provided over the opening of a corresponding waveguide.

With the above-described structure, electric waves can be radiated or received even if the difference of longitude between a plurality of satellites is small and those satellites have different frequency bands.

Feed horn 20 in which dielectric rod 14 has radiant part 51 located on the outer side of waveguide 10 and impedance matching part 52 to be inserted into waveguide 10, radiant part 51 has a cross section of a cruciform along the entire length of radiant part 51, and the length of a side of the cruciform decreases with distance from opening 101.

With the above-described structure, a plurality of polarized waves can be received.

Feed horn 20 in which dielectric rod 14 has radiant part 51 located on the outer side of waveguide 10 and impedance matching part 52 to be inserted into waveguide 10, radiant part 51 has a shape of one of a truncated cone and a truncated pyramid, and hollow portion 63 is formed in the truncated cone and the truncated pyramid.

With the above-described structure, the possibility that air bubbles or sink marks are produced in dielectric rod 14 can be reduced.

Feed horn 20 in which waveguide 10 has a cross section of one of a square and a circle, and along the entire length of impedance matching part 52, impedance matching part 52 has an axially symmetric shape with respect to two axes passing through the center of the cross section of waveguide 10 and perpendicular to each other in the cross section.

With the above-described structure, the cross polarization characteristic can be increased.

Feed horn 20 in which impedance matching part 62 has corrugated groove 621 provided along opening 101 of waveguide 10.

With the above-described structure, impedance matching between waveguide 10 and dielectric rod 14 is improved.

Feed horn 20 in which plurality of primary radiating elements 41 to 43 have corrugated grooves 102, 112 and 122 provided on the peripheries of openings 101, 111 and 121 of waveguides 10 to 12, respectively.

With the above-described structure, impedance matching between waveguide 10 and dielectric rod 14 is improved.

Feed horn 20 in which plurality of primary radiating elements 41 to 43 are formed integrally.

With the above-described structure, feed horn 20 can be reduced in size.

Feed horn 20 further including cap 17 covering at least two dielectric rods as a whole, the material of cap 17 having a dielectric constant which is less than or equal to the dielectric constant of dielectric rods 14 to 16.

With the above-described structure, raindrops are prevented from adhering to dielectric rods 14 to 16. Therefore, feed horn 20 can radiate or receive electric waves stably as designed even during rainfall. Moreover, it becomes easy to obtain impedance matching between dielectric rods 14 to 16 and air.

Feed horn 20 in which cap 17 has a shape of one of a cylinder and a prism which extends in the radiation direction of dielectric rods 14 to 16.

With the above-described structure, constant distances can be ensured between the leading edge of dielectric rods 14 to 16 and bottom 171 of cap 17.

Feed horn 20 in which cap 17 has a shape of one of a truncated cone and a truncated pyramid which tapers from impedance matching part 52 toward radiant part 51 along the axial direction of waveguides 10 to 12.

With the above-described structure, cap 17 has a reduced volume. Feed horn 20 can thereby be reduced in size and made compact.

Feed horn 20 in which cap 17 has a shape of one of an inverted truncated cone and an inverted truncated pyramid which widens from impedance matching part 52 toward radiant part 51 along the axial direction of waveguides 10 to 12.

With the above-described structure, constant distances can be ensured between the leading edge of dielectric rods 14 to 16 and cap 17.

Feed horn 20 in which the distance between the leading edge of radiant part 51 of at least one of the at least two dielectric rods and cap 17 is an integral multiple of approximately ½ of a wavelength corresponding to the center frequency of an electric wave.

With the above-described structure, the electric wave radiated from the dielectric rod and the electric wave reflected from cap 17 are the same in phase. Accordingly, efficient radiation or reception of electric waves is possible.

Parabolic antenna 40 including feed horn 20, frequency converter 30 converting the frequency of electric waves from plurality of satellites S received by feed horn 20, and parabolic reflector 31 receiving electric waves, parabolic reflector 31 having an elliptical shape whose longitudinal axis extends in the horizontal plane direction.

With the above-described structure, electric waves can be radiated or received even if the difference of longitude between a plurality of satellites is small and those satellites have different frequency bands from each other.

It should be understood that the embodiments disclosed herein are illustrative and non-restrictive in every respect. The scope of the present invention is defined by the claims not by the description above, and is intended to include any modification within the meaning and scope equivalent to the terms of the claims.

### REFERENCE SIGNS LIST

9 main body; 10-12 waveguide; 101, 111, 121 opening; 203, 204 circular waveguide; 205 united section; 102, 112, 122, 213, 214, 621 corrugated groove; 14-16 dielectric rod; 142 truncated pyramidal rod; 143 truncated conical rod; 20 feed horn; 17 cap; 171 bottom; 20 feed horn; 31 parabolic reflector; 32 support arm; 33 support mast; 40 parabolic antenna; 41-43 primary radiating element; 211, 212 horn; 51, 61, 71 radiant part; 511, 512; trapezoidal portion; 52, 62 impedance matching part; 521, 522 plate-like part; 53 boundary plane; 622 conical portion; 63 hollow portion; S satellite.

1-5. (canceled)

6. A primary radiator comprising a plurality of primary radiating elements,
said plurality of primary radiating elements each including a waveguide having an opening,
at least two primary radiating elements of said plurality of primary radiating elements each further including a radiating element of a dielectric material provided over said opening of said waveguide,
said radiating element has
a radiant part located on an outer side of said opening of said waveguide,
an impedance matching part to be inserted into said opening of said waveguide,
said radiant part has a cross section of a cruciform along the entire length of said radiant part,
the length of a side of said cruciform decreases with distance from said opening of said waveguide,
said waveguide has a cross section of one of a square and a circle, and
along the entire length of said impedance matching part, said impedance matching part has an axially symmetric shape with respect to two axes passing through the center of said cross section of said waveguide and perpendicular to each other in said cross section.

7. A primary radiator comprising a plurality of primary radiating elements,
said plurality of primary radiating elements each including a waveguide having an opening,
at least two primary radiating elements of said plurality of primary radiating elements each further including a radiating element of a dielectric material provided over said opening of said waveguide,
a radiant part located on an outer side of said opening of said waveguide,
an impedance matching part to be inserted into said opening of said waveguide,
said radiant part has a shape of one of a truncated cone and a truncated pyramid,
a hollow portion is formed in said truncated cone and said truncated pyramid,
said waveguide has a cross section of one of a square and a circle, and
along the entire length of said impedance matching part, said impedance matching part has an axially symmetric shape with respect to two axes passing through the center of said cross section of said waveguide and perpendicular to each other in said cross section.

8. The primary radiator according to claim 6, further comprising a dielectric cap covering said plurality of primary radiating elements as a whole.

9. The primary radiator according to claim 7, further comprising a dielectric cap covering said plurality of primary radiating elements as a whole.
